(19) United States
(12) Patent Application Publication
(10) Pub. No.: US 2026/0050276 A1
(43) Pub. Date: Feb. 19, 2026

(54) IMAGE PROCESSING APPARATUS, WARM/COLD SENSE PRESENTATION APPARATUS, CONTROL METHOD AND STORAGE MEDIUM STORING CONTROL PROGRAM FOR IMAGE PROCESSING APPARATUS

(71) Applicant: CANON KABUSHIKI KAISHA, Tokyo (JP)

(72) Inventor: TAKAHIRO USAMI, Tokyo (JP)

(21) Appl. No.: 19/370,067

(22) Filed: Oct. 27, 2025

Related U.S. Application Data
(63) Continuation of application No. PCT/JP2024/017370, filed on May 10, 2024.

(30) Foreign Application Priority Data
May 19, 2023 (JP) 2023-083047

(51) Int. Cl. G05D 23/19; G06V 10/764; G06V 20/00; G06V 40/10

(52) U.S. Cl. CPC G05D 23/1917; G06V 10/764; G06V 20/35; G06V 40/10

(57) ABSTRACT

An image processing apparatus that can decide whether to perform temperature control on a desired object in an image and have a degree of freedom in a control range of a presented temperature. The image processing apparatus includes an image data input unit that inputs image data of the image, an object detection unit that detects the object in the image based on the image data, a type identification unit that identifies a type of the object detected by the object detection unit, a control determination unit that determines whether to perform temperature control to an object occupied area that is occupied by the object in the image based on an identification result of the type identification unit, and a temperature decision unit that decides a temperature of the object occupied area when it is determined to perform the temperature control as a determination result of the control determination unit.

### CROSS-REFERENCE TO RELATED APPLICATIONS

This application is a Continuation of International Patent Application No. PCT/JP2024/017370, filed May 10, 2024, which claims the benefit of Japanese Patent Application No. 2023-083047, filed May 19, 2023, both of which are hereby incorporated by reference herein in their entirety.

### BACKGROUND

### Field of the Technology

The present disclosure relates to an image processing apparatus capable of controlling temperature of an image, a warm/cold sense presentation apparatus, a control method and a storage medium storing a control program for the image processing apparatus.

### Description of the Related Art

Conventionally, there is known a display that includes Peltier elements capable of switching between cooling and heating arranged in a matrix and that is capable of displaying an image (for example, see Non Patent literature 1). The display disclosed in Non Patent Literature 1 can be cooled or heated by controlling each of the Peltier elements in a state where an image is displayed. This allows a user who uses the display to touch the display and feel cold or warm, that is, warm/cold sense is presented.

### Citation List

### Non Patent Literature

NPL1: Hisako Kushiyama, Koki Doi, Shinji Sasada, Tetsyaki Baba, Thermo Drawing: Development of Temperature Drawing System Using Small Tactile Display by Presenting Cold/Hot Sence, Information Processing Society of Japan, Interaction 2012, Mar. 16, 2012, pp. 723-728.

However, the display disclosed in Non Patent Literature 1 presents a warm/cold sense also to a portion where the presentation of the warm/cold sense is not desired, even if, for example, the user desires the presentation of the warm/cold sense of a specific object in the image in performing the temperature control (temperature adjustment) of the entire image. In addition, various conditions such as a type of a specific object may prohibit free adjustment and setting of the control range of the temperature.

### SUMMARY

The present disclosure provides an image processing apparatus, a warm/cold sense presentation apparatus, a control method and a storage medium storing a control program for the image processing apparatus, which can decide whether to perform temperature control on a desired object in an image and have a degree of freedom in a control range of a presented temperature.

Accordingly, an aspect of the embodiments provides an image processing apparatus capable of processing an image including an object, the image processing apparatus including an image data input unit configured to input image data of the image, an object detection unit configured to detect the object in the image based on the image data, a type identification unit configured to identify a type of the object detected by the object detection unit, a control determination unit configured to determine whether to perform temperature control to an object occupied area that is occupied by the object in the image based on an identification result of the type identification unit, and a temperature decision unit configured to decide a temperature of the object occupied area in a case where it is determined to perform the temperature control as a determination result of the control determination unit.

Features of the present disclosure will become apparent from the following description of exemplary embodiments with reference to the attached drawings.

### BRIEF DESCRIPTION OF THE DRAWINGS

FIG. 1 is a block diagram illustrating a hardware configuration of a warm/cold sense presentation apparatus according to a first embodiment.

FIGS. 2A and 2B are schematic views for describing a relationship between image data input to an image data input part and warm/cold sense presentation in a warm/cold sense presentation part.

FIG. 3 is a view for describing generation of warm/cold sense presentation area data by associating a warm/cold sense presentation area with temperature data.

FIG. 4 is a flowchart illustrating a warm/cold sense presentation process executed by the warm/cold sense presentation apparatus.

FIG. 5 is a block diagram illustrating a hardware configuration of a warm/cold sense presentation apparatus according to a second embodiment.

FIG. 6 is a schematic view illustrating a use state of the warm/cold sense presentation apparatus shown in FIG. 5.

FIG. 7 is a block diagram illustrating a hardware configuration of a warm/cold sense presentation apparatus according to a third embodiment.

FIG. 8 is a schematic view illustrating a use state of the warm/cold sense presentation apparatus shown in FIG. 7.

FIG. 9 is a schematic view illustrating a configuration of a warm/cold sense presentation apparatus according to a fourth embodiment.

FIG. 10 is a schematic view illustrating a configuration of a warm/cold sense presentation apparatus according to a fifth embodiment.

### DESCRIPTION OF THE EMBODIMENTS

Hereinafter, embodiments of the present disclosure will be described in detail with reference to the drawings. However, configurations described in the following embodiments are merely examples, and the scope of the present disclosure is not limited by the configurations described in the embodiments. For example, each part constituting the present disclosure can be replaced with any configuration capable of exhibiting the same function. In addition, an arbitrary constituent may be added. Any two or more configurations (features) of the embodiments can be combined.

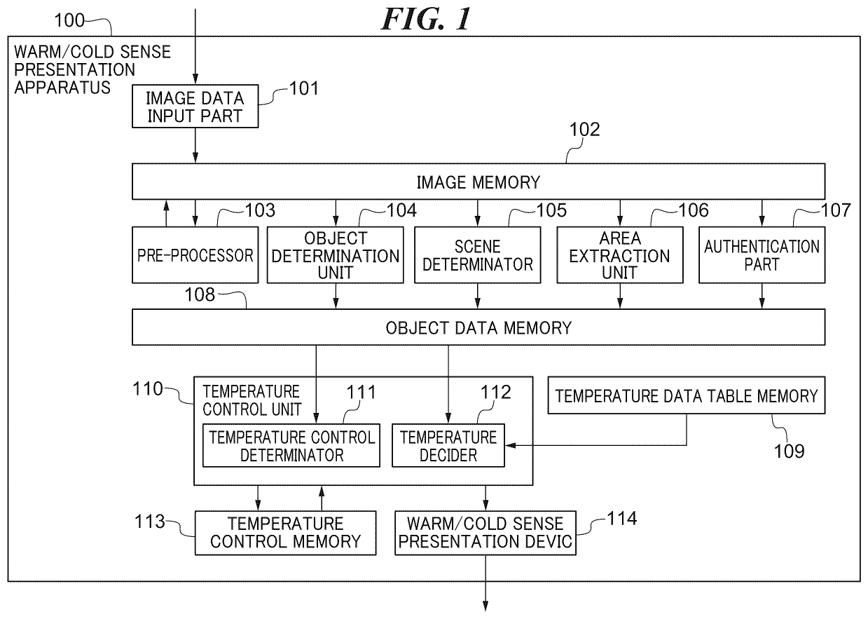

Hereinafter, a first embodiment will be described with reference to FIG. 1 to FIG. 4. FIG. 1 is a block diagram illustrating a hardware configuration of a warm/cold sense presentation apparatus 100 according to the first embodiment. The warm/cold sense presentation apparatus 100 in FIG. 1 is an apparatus to which an image processing apparatus capable of processing an image including an object is applied. The warm/cold sense presentation apparatus 100 includes an image data input part (an image data input unit) 101, an image memory 102, a pre-processor 103, an object determination unit 104, a scene determinator (a scene determination unit) 105, an area extraction unit 106, and an authentication part (an authentication unit) 107.

The warm/cold sense presentation apparatus 100 includes an object data memory 108, a temperature data table memory (a storage unit) 109, a temperature control unit 110, a temperature control memory 113, and a warm/cold sense presentation device 114. In addition, the warm/cold sense presentation apparatus 100 also includes a memory (not illustrated) that stores various programs. These programs are not particularly limited, and include, for example, a program for causing a computer (CPU) to execute each part or each unit (a control method for the image processing apparatus) of the warm/cold sense presentation apparatus 100.

Image data of an image is input to the image data input part 101 (an image data input step). The image data input part 101 includes an I/F (interface) to input a digital image data signal. The I/F is not particularly limited, and for example, an HDMI (registered trademark) terminal can be used. In this case, the image data input part 101 receives a video signal conforming to the HDMI standard and extracts the image data from the video signal.

The image data input part 101 writes the extracted image data to the image memory 102. The image data input part 101 may have a configuration including an I/F into which a memory card capable of reading and writing high-resolution image data at high speed, such as an SD card or a CFexpress card, is inserted and removed. In this case, the image data input part 101 reads the image data recorded in the memory card and writes the read image data in the image memory 102. The image memory 102 is, for example, a DRAM or an SRAM, and records the image data. The pre-processor 103 reads the image data recorded in the image memory 102 and executes image processes on the read image data.

The image processes are suitable for processes performed by the object determination unit 104, the scene determinator 105, the area extraction unit 106, and the authentication part 107, for example. Note that, for example, in a case where image data is configured by a YUV signal, the image processes include gamma correction, shading correction, white balance correction, and the like performed on the YUV signal. In addition, in a case where image data is configured with a pixel pattern of a Bayer array, the image processes may include a de-mosaic process of performing a color interpolation process such that one pixel has values of all RGB components, a geometric deformation process, a noise reduction process, and a resize process. The pre-processor 103 writes image data obtained by executing the image processes in the image memory 102.

The object determination unit 104 reads the image data recorded in the image memory 102, and detects at least one predetermined object from the image based on the read image data (an object detection step). The object determination unit 104 can also detect a position and size of the object in the image. Then, the object determination unit 104 identifies an object type that is a type of the object detected in the object detection step (a type identification step).

The object type is not particularly limited, and the object type may be an animal, such as a human, a dog, a cat, a bird, or an insect, a moving object, such as an automobile or an airplane, or a still object such as a ball. When an animal including a human is identified as the object type, body parts of the animal are further identified. For example, when a human is identified, for example, a head, a chest, an abdomen, arms, legs, and the like are further identified. The object determination unit 104 writes information, which associates the identification result of the object type with reliability, as object data in the object data memory 108. Note that a known method can be used as each of an object detection method for detecting an object and a type identification method for identifying an object type.

The object determination unit 104 may detect an object using machine learning or identify an object type using machine learning. In this case, the object determination unit 104 preferably includes a GPU, a TPU, or the like. Then, the object determination unit 104 can be configured as a class identifier that has been learned using learning data. Although deep learning can be used as a machine learning algorithm, this is not limited, and for example, a support vector machine, logistic regression, a decision tree, a random forest, or the like can also be used. Such machine learning improves accuracies of detection of an object and identification of an object type.

In the present embodiment, the object determination unit 104 has a function of an object detection unit that detects an object in an image and a function of a type identification unit that identifies a type of an object detected in the object detection step. That is, the object detection unit and the type identification unit are integrated into the object determination unit 104 (one unit). Accordingly, the hardware configuration of the warm/cold sense presentation apparatus 100 can have a simple configuration. Note that the object detection unit and the type identification unit may be constituted by mutually independent units. In this case, hardware (devices) suitable for the object detection unit and the type identification unit can be used.

The scene determinator 105 reads the image data recorded in the image memory 102, and determines what kind of scene the image is based on the read image data. The scene determinator 105 writes the determination result in the object data memory 108. The scene of the image is not particularly limited, and examples thereof include an indoor scene, a night scene, an evening scene, a spring landscape, a summer landscape, an autumn landscape, a winter landscape, a backlight scene, and the like. The scene determinator 105 is configured by, for example, a scene classifier that has been leaned using learning data. A machine learning algorithm in the scene classifier is not particularly limited.

The area extraction unit 106 reads the image data recorded in the image memory 102, and detects at least one area of a predetermined type based on the read image data. The area extraction unit 106 writes, for each detected area, map information obtained by mapping the area occupied in the image and a type of the area (for example, the sky, human skin, grass, or the like) as area data in the object data memory 108. The area extraction unit 106 is configured by, for example, an area map generator that has been learned using learning data. The machine learning algorithm in the area map generator is not particularly limited.

The authentication part 107 may authenticate the object type identified by the object determination unit 104. Specifically, the authentication part 107 writes authentication data necessary for the authentication in the object data memory 108 in advance, and reads the object data written by the object determination unit 104 from the object data memory 108. Then, when the object data has the type of the object that is an authentication target, the authentication part 107 reads the authentication data from the object data memory 108. In addition to reading the authentication data, the authentication part 107 cuts out the area of the object that is the authentication target from the image data recorded in the image memory 102, and reads the area as authentication target data.

The authentication part 107 performs object authentication by calculating a matching degree between the authentication data and the authentication target data, and writes the result of the object authentication into the object data memory 108. A method of calculating the matching degree between the authentication data and the authentication target data is not particularly limited. For example, the total amount of the difference absolute values of the respective pixel values between the authentication data and the authentication target data is calculated as the matching degree. When the total amount is less than a predetermined threshold, it is determined that the authentication data matches the authentication target data. For example, a human face shall be identified as the object type. When the human face is identified as the object type, positions of parts such as eyes, a nose, and a mouth of the human are extracted by a part extractor, and the matching degree between the positions of the parts obtained by the extraction and the positions of the parts in the authentication data is calculated.

In addition, when one object is captured from a plurality of viewpoints and a plurality of image data are obtained, a three-dimensional shape of the one object is calculated based on the plurality of obtained image data, and the matching degree can be calculated from the difference between the structure of the authentication data and the structure of the authentication target data. The machine learning algorithm in the authentication part 107 is not particularly limited. The object data memory 108 is, for example, a DRAM or an SRAM, and stores, for example, information (data) about an object, information about a scene, information about an area, a result of the object authentication, and the like.

A temperature data table memory 109 is, for example, a DRAM or an SRAM, and stores in advance temperature information related to temperature of each object type as a table. The temperature information indicates, for example, 36 degrees in a case where the object type is a human, 38 degrees in a case where the object type is a dog, and 40 degrees in a case where the object type is a bird. In addition, when the object is a high-temperature object such as a firework, the temperature information indicates, for example, 50 degrees. The temperature data table memory 109 stores in advance temperature information about temperature of each scene determined by the scene determinator 105 as a table.

The temperature information about the scene indicates, for example, 15 degrees in a case where the scene is the “night scene”, 20 degrees in a case where the scene is the “evening scene”, and 25 degrees in a case where the scene is the “indoor scene”. In addition, the temperature data table memory 109 stores in advance the temperature information related to the temperature of each type of an area detected by the area extraction unit 106 as a table. The temperature information for each type of an area indicates, for example, 15 degrees in a case where the type of area is “the sky”, 36 degrees in a case of the “human skin”, and 24 degrees in a case of the “grass”.

The temperature control unit 110 includes a temperature control determinator (a temperature control determination unit) 111 and a temperature decider (a temperature decision unit) 112. The temperature control determinator 111 reads the object data written in the object data memory 108 by the object determination unit 104 from the object data memory 108. The temperature control determinator 111 determines whether to execute temperature control on an “object occupied area” that is an area occupied by the object in the image on the basis of the identification result of the type of the object included in the read object data (a control determination step).

When the temperature control determinator 111 determines that the temperature control is to be executed as a result of the determination, the temperature decider 112 decides the temperature of the object occupied area based on the temperature information stored in the temperature data table memory 109 (a temperature decision step). The temperature decider 112 writes information about the determined temperature in the temperature control memory 113. The warm/cold sense presentation device 114 presents a warm/cold sense to a user using the warm/cold sense presentation apparatus 100, that is, conveys warmth/coldness to the user. The warm/cold sense presentation device 114 can read the decided temperature written in the temperature control memory 113 from the temperature control memory 113 and reflect the read decided temperature to the warm/cold sense presentation.

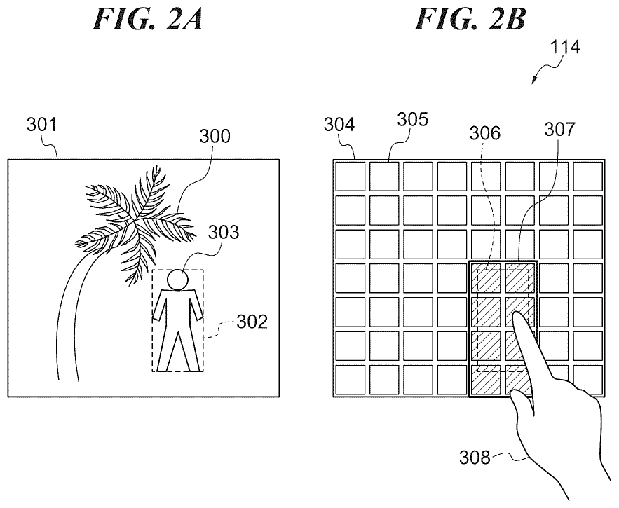

FIGS. 2A and 2B are schematic diagrams for describing a relationship between image data input to the image data input part 101 and the warm/cold sense presentation in the warm/cold sense presentation device 114. The warm/cold sense presentation device 114 includes a warm/cold sense presentation area 304 that presents the warm/cold sense. In the warm/cold sense presentation area 304, a plurality of warm/cold sense presentation elements 305 configured by, for example, Peltier elements are arranged in a matrix (in the configuration illustrated in FIG. 2B, seven rows vertically and eight columns horizontally). Input image data 301 input to the image data input part 101 is data of an image including a human 303 and a tree 300. The input image data 301 includes information about a rectangular human area 302 in which the human 303 is inscribed. The warm/cold sense presentation device 114 can scale the full angle of view of the input image data 301 to the warm/cold sense presentation area 304.

At this time, in the warm/cold sense presentation area 304, a human corresponding area 306 having the same aspect ratio as the human area 302 is formed at a position corresponding to the human area 302. Then, a human warm/cold sense presentation area 307 constituted by one or more warm/cold sense presentation elements 305 each of which at least partially overlaps the human corresponding area 306 is set. The human warm/cold sense presentation area 307 corresponds to an object occupied area occupied by an object in the image. The temperature control determinator 111 determines whether to execute the temperature control of the human warm/cold sense presentation area 307, that is, whether to set the human warm/cold sense presentation area 307 as a target area of the temperature control. When the human warm/cold sense presentation area 307 is set as the target area of the temperature control, the temperature decider 112 decides the temperature presented in the human warm/cold sense presentation area 307. In the example illustrated in FIG. 2B, since the human warm/cold sense presentation area 307 is an area where the warm/cold sense of the human 303 (person) is presented, the presented temperature is decided to be 36 degrees. The user can sense the temperature (body temperature) of the human 303 by touching the human warm/cold sense presentation area 307 with a finger 308.

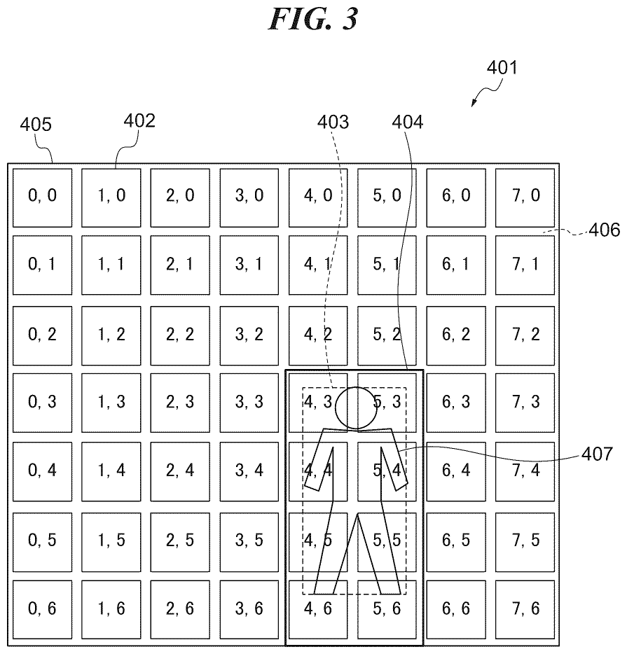

FIG. 3 is a diagram for describing a method of generating warm/cold sense presentation area data by associating a warm/cold sense presentation area 405 with temperature data. A warm/cold sense presentation device 401 illustrated in FIG. 3 corresponds to the warm/cold sense presentation device 114. The warm/cold sense presentation device 401 includes a plurality of warm/cold sense presentation elements 402 arranged in a matrix (in the configuration illustrated in FIG. 3, seven rows vertically and eight columns horizontally) on the back surface side of the warm/cold sense presentation device 401. In the present embodiment, the respective warm/cold sense presentation elements 402 are assigned with coordinates of (0, 0) to (7, 6) from the upper left to the lower right in FIG. 3. Each of the warm/cold sense presentation elements 402 is configured by, for example, a Peltier element. Each of the warm/cold sense presentation elements 402 is electrically controlled to cool and heat. This enables temperature adjustment for each of the warm/cold sense presentation elements 402, and thus a warm/cold sense can be presented for each of the warm/cold sense presentation elements 402.

In this manner, the plurality of warm/cold sense presentation elements 402 constitute the warm/cold sense presentation area 405 that presents warm/cold sense. The warm/cold sense presentation device 401 can scale the full angle of view of the input image data (for example, the input image data 301) to the full area of the warm/cold sense presentation area 405. In this case, the temperature control unit 110 calculates to which coordinate of the warm/cold sense presentation element 402 in the warm/cold sense presentation area 405 corresponds to an “object area” that is occupied by an object read from the input image data. The temperature control unit 110 assigns the temperature data of the object to the warm/cold sense presentation element 402 corresponding to the coordinate calculated.

For example, when a human corresponding area 403 as the object area is a rectangular area surrounded by a broken line in FIG. 3, the warm/cold sense presentation elements 402 at the coordinates (4, 3) to (4, 6) and (5, 3) to (5, 6) at least partially overlap the human corresponding area 403. The warm/cold sense presentation elements 402 at the coordinates (4, 3) to (4, 6) and (5, 3) to (5, 6) constitute the human warm/cold sense presentation area 404. Then, the temperature information “36 degrees” for the object type “human” read from the temperature data table memory 109 and determined by the temperature decider 112 is assigned to each of the warm/cold sense presentation elements 402 constituting the human warm/cold sense presentation area 404.

In the present embodiment, the warm/cold sense presentation device 401 includes a display 406 arranged on the front side of the warm/cold sense presentation device 401. The display 406 is not particularly limited, and examples thereof include an organic EL display and a liquid crystal display. Thus, the warm/cold sense presentation device 401 has a function as a display part that displays input image data as an image, and can display an image including a human 407 as illustrated in FIG. 3, for example. The human corresponding area 403 is an area in which the human 407 is inscribed. Each of the warm/cold sense presentation elements 402 functions as a temperature adjustment unit that adjusts the temperature of the human 407 displayed on the display 406 to the temperature determined by the temperature decider 112. Thus, the user can feel the temperature of the human 407 by touching the warm/cold sense presentation elements 402 constituting the human warm/cold sense presentation area 404 with a finger (body).

The display 406 (the warm/cold sense presentation device 401) may visualize and display the temperature of the human warm/cold sense presentation area 404 on the image. The method of “visualizing and displaying” is not particularly limited. It is preferable that the display 406 (the warm/cold sense presentation device 401) displays the human warm/cold sense presentation area 404 by increasing density of red as the temperature of the human warm/cold sense presentation area 404 increases and displays the human warm/cold sense presentation area 404 by increasing density of blue as the temperature of the human warm/cold sense presentation area 404 decreases. Accordingly, the user can visually understand the body temperature of the object (for example, the human 407) without touching the human warm/cold sense presentation area 404 by visually recognizing the display 406.

The display 406 may visualize and display a degree of deviation between the temperature of the human warm/cold sense presentation area 404 (object occupied area) and the average body temperature of a human (animal) on the image. The method of “visualizing and displaying” is not particularly limited. For example, when the temperature of the human warm/cold sense presentation area 404 is deviated from the average body temperature in a direction increasing the temperature, it is preferable that the display 406 displays the human warm/cold sense presentation area while heightening density of red. On the contrary, for example, when the temperature of the human warm/cold sense presentation area 404 is deviated from the average body temperature in a direction decreasing the temperature, the display 406 preferably displays the human warm/cold sense presentation area while heightening density of blue. Accordingly, when the temperature of the human 407 is higher than the average body temperature of the human due to, for example, heat stroke, the user can understand that the body temperature is high without touching the human warm/cold sense presentation area 404 by visually recognizing the display 406.

In addition, for example, when a plurality of objects are included in an image and the object areas overlap in the warm/cold sense presentation area 405, the temperature information of an object having a higher temperature may be assigned to the object area or the temperature information of an object having a lower temperature may be assigned to the object area. The temperature information of the object may be assigned based on a priority of an object type. The priority order of the object types can be arbitrarily determined in advance.

The warm/cold sense presentation apparatus 100 includes a setting unit (not shown) to set in advance the type of the object that can be a temperature control target of the warm/cold sense presentation device 114. Accordingly, for example, when the image includes the human 303 and tree 300 as illustrated in FIG. 2, the type of the object that can be the temperature control target can be set to the human 303 instead of the tree 300. The setting unit is not particularly limited, and examples thereof include an operation unit to which a user performs an operation of inputting various information, commands, and the like to the warm/cold sense presentation apparatus 100.

As described above, the temperature control unit 110 of the temperature control determinator 111 reads the object data written in the object data memory 108 by the object determination unit 104 from the object data memory 108. Then, the temperature control determinator 111 determines whether to execute the temperature control on the object occupied area in the image based on the identification result of the object type included in the read object data, that is, the identification result by the object determination unit 104.

In this determination, the temperature control determinator 111 determines to execute the temperature control for the object occupied area when the object type identified by the object determination unit 104 matches the object type set in advance by the setting unit. In addition, when executing the temperature control, the temperature control determinator 111 calculates, based on the position and the size of the object that can be the temperature control target in the image, which area of the warm/cold sense presentation area 304 (405) of the warm/cold sense presentation device 114 corresponds to the object occupied area occupied by the object. The temperature control determinator 111 decides the warm/cold sense presentation area 304 (405) to be the temperature control target based on the calculation result. On the other hand, when the object type identified by the object determination unit 104 does not match the object type set in advance by the setting unit, the temperature control determinator 111 determines not to execute the temperature control on the object occupied area.

The temperature control determinator 111 outputs information about the object type to the temperature decider 112. Based on the information, the temperature decider 112 outputs the temperature data of the object type to the temperature control determinator 111. Accordingly, the temperature control determinator 111 receives the temperature data of the object type from the temperature decider 112, associates the received temperature data with the warm/cold sense presentation area 304 (405), and writes them as the temperature control data in the temperature control memory 113.

In the present embodiment, the determination of whether to execute temperature control on the object occupied area is performed based on whether the object type identified by the object determination unit 104 matches the object type set in advance by the setting unit. However, the determination of whether to execute the temperature control on the object occupied area is not limited to this, and may be performed based on, for example, whether the object type identified by the object determination unit 104 is authenticated by the authentication part 107.

Specifically, the authentication part 107 reads the result of the object authentication written in the object data memory 108. When the authentication is passed as a result of the object authentication by the authentication part 107, that is, when the object type identified by the object determination unit 104 is authenticated by the authentication part 107, the temperature control determinator 111 determines to execute the temperature control. Following this determination, a decision is also made by the temperature decider 112. On the other hand, when the authentication is not passed as a result of the object authentication by the authentication part 107, that is, when the object type identified by the object determination unit 104 is not authenticated by the authentication part 107, the temperature control determinator 111 may determine not to execute the temperature control. The determination of whether to execute the temperature control based on the authentication result by the authentication part 107 may be arbitrarily set in the warm/cold sense presentation apparatus 100.

The temperature data table memory 109 stores the temperature data listed for the respective object types. The temperature decider 112 reads the temperature data for the object type from the temperature data table memory 109 based on the object type input from the temperature control determinator 111. The temperature decider 112 outputs the read temperature data to the temperature control determinator 111. The image data input part 101 of the warm/cold sense presentation apparatus 100 may further include, for example, a temperature data input part to input temperature data corresponding to the full angle of view of image data from the outside of the warm/cold sense presentation apparatus 100.

The temperature decider 112 may extract the temperature data of the object area from the temperature data input via the temperature data input part and output the temperature data to the temperature control determinator 111. In addition, when the temperature data is configured by a plurality of temperature data of a plurality of regions in the object area, a smoothing process may be executed on the plurality of temperature data to obtain one temperature data, and the obtained one temperature data may be output to the temperature control determinator 111. In addition, the temperature data that are different for the respective warm/cold sense presentation elements 402 (see FIG. 3), that is, for the respective coordinates may be output to the temperature control determinator 111.

The warm/cold sense presentation apparatus 100 may include a temperature reasoner that has been learned using learning data and reasons temperature of a specific type of object. In this case, the input image data may be input to the temperature reasoner, and the temperature decider 112 may output the temperature data, which is the reasoning result obtained by the temperature reasoner, to the temperature control determinator 111 as the temperature data of the object. In a case where there are a plurality of temperature data obtaining methods (obtaining units), such as “extraction from the input temperature data”, “reading of the temperature data from the temperature data table (list)”, and “reasoning by the temperature reasoner”, the temperature decider 112 may appropriately switch the obtaining method in accordance with the object type input from the temperature control determinator 111.

For example, when the object type is a human, the temperature decider 112 obtains the temperature data by reasoning by the temperature reasoner. When the object type is a dog or a cat, the temperature decider 112 obtains the temperature data extracted from the input temperature data. When the object type is a firework, the temperature decider 112 reads the temperature data from the temperature data table. In this way, when the temperature decider 112 switches the temperature data obtaining unit on the basis of the object type input from the temperature control determinator 111, it is possible to obtain more accurate temperature data even for the object type that makes it difficult to obtain accurate temperature data by a fixed obtaining unit. In this way, when deciding the temperature of the object occupied area, the temperature decider 112 can decide an appropriate temperature by changing the temperature data obtaining method in accordance with the object type.

When deciding the temperature of the object occupied area, the temperature decider 112 can set at least one of an upper limit of the temperature and a lower limit of the temperature in accordance with the object type. For example, in the case of a high-temperature object such as a firework, the actual temperature of the object is 370 degrees in the case of a sparkling firework and 1100 degrees or higher in the case of a blow-out firework. Such a high temperature output is substantially impossible when the warm/cold sense presentation element 305 is configured by a Peltier element. Even if a high temperature output is possible, a user cannot touch such an object occupied area of the high temperature object.

Therefore, when the object type is a high-temperature object, it is preferable to set an upper limit to the temperature of the object and decide the temperature. This allows the temperature of the warm/cold sense presentation elements 305 to be adjusted, and the user to touch the object occupied area of the high-temperature object. An upper limit value depends on the object type and may be set to 50 degrees in a case where the object type is a firework, for example. The upper limit values shall be stored in advance in the temperature data table memory 109 for the respective object types. The temperature decider 112 can set a lower limit of the temperature in the same manner as the upper limit of the temperature. In addition, when deciding the temperature, a temperature between the upper limit and the lower limit of the temperature that can be output by the warm/cold sense presentation element 305 may be used. For example, when the upper limit of the temperature that can be output by the warm/cold sense presentation element 305 is 40 degrees, the temperature of an object of which the temperature exceeds 40 degrees may be uniformly decided to be 40 degrees. In addition, when the lower limit of the temperature that can be output by the warm/cold sense presentation element 305 is 5 degrees, the temperature of an object of which the temperature is lower than 5 degrees may be uniformly decided to be 5 degrees.

As described above, the scene determinator 105 determines what kind of scene the image is, and writes the determination result in the object data memory 108. The temperature control determinator 111 reads the determination result by the scene determinator 105, that is, the scene information indicating what kind of scene the image is, from the object data memory 108, and outputs the scene information to the temperature decider 112. The temperature decider 112 outputs the temperature information of the scene based on the scene information read from the object data memory 108 to the temperature control determinator 111.

This allows the temperature control determinator 111 to receive the temperature information of the scene from the temperature decider 112. In this case, the temperature control determinator 111 may have a scene temperature generation function that obtains offset temperature of the entire warm/cold sense presentation area in the warm/cold sense presentation device 114 based on the temperature information of the scene and writes the offset temperature in the temperature control memory 113. Accordingly, for example, when the entire warm/cold sense presentation area 304 (405) is an object area, an offset process in which the temperature of the scene is added to or subtracted from the temperature data of the object is performed. Both the temperature data of the object and the temperature information of the scene may be reflected to the object area (the entire warm/cold sense presentation area 304 (405)). In addition, for example, when the entire warm/cold sense presentation area 304 (405) is the object area, the temperature of the scene may be ignored.

The temperature decider 112 may decide the temperature of the object occupied area based on the determination result of the scene determinator 105. Specifically, when the scene temperature generation function is enabled, the temperature decider 112 reads the temperature data prepared for the respective scenes in the temperature data table memory 109 based on the scene information from the temperature control determinator 111. The temperature decider 112 reflects the read temperature data to the temperature of the object occupied area.

The temperature control determinator 111 outputs the area data read from the object data memory 108 to the temperature decider 112. The temperature control determinator 111 receives temperature information of a specific type area from the temperature decider 112. In this case, the temperature control determinator 111 may have an area temperature generation function that writes the temperature information of the specific type area as an offset temperature in the temperature control memory 113. Accordingly, for example, when the specific type area overlaps the object area, an offset process in which the temperature of the specific type area is added to or subtracted from the temperature data of the object is performed.

Further, both the temperature data of the object and the temperature data of the specific type area may be reflected to the object area. For example, when the specific type area overlaps the object area, the temperature of the specific type area may be ignored. When the area temperature generation function is enabled, the temperature decider 112 reads the temperature data prepared for the respective type areas in the temperature data table memory 109 based on the area data received from the temperature control determinator 111. The temperature decider 112 reflects the read temperature data to the temperature of the object occupied area.

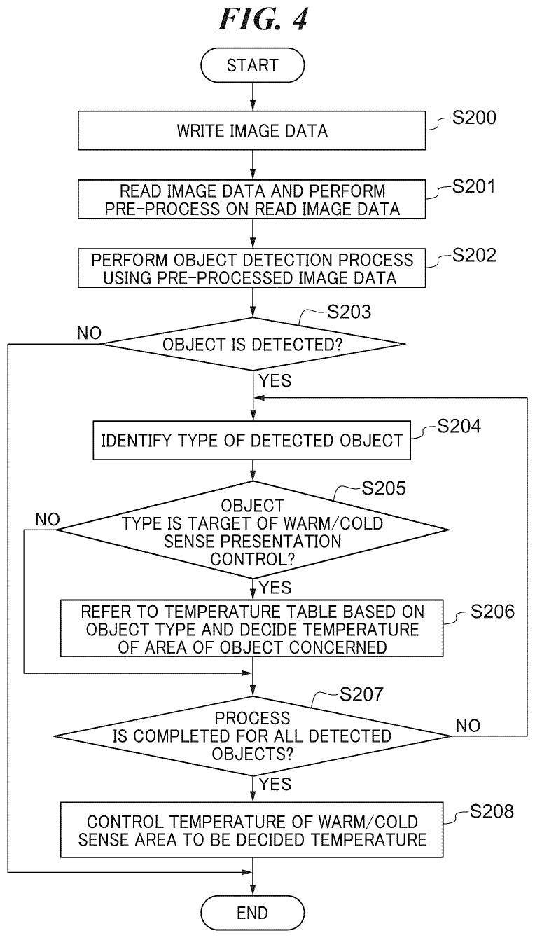

FIG. 4 is a flowchart illustrating a warm/cold sense presentation process executed by the warm/cold sense presentation apparatus 100. First, in step S200, the image data input part 101 writes the input image data in the image memory 102.

In step S201, the pre-processor 103 reads the image data written in step S200 from the image memory 102. Then, the pre-processor 103 performs, on the read image data, an image process suitable for an object detection process in which the object determination unit 104 detects at least one predetermined object from the image (a pre-process). The pre-processor 103 writes the image data after the image process in the image memory 102.

In step S202, the object determination unit 104 reads the image data written in step S201 from the image memory 102 and performs the object detection process.

In step S203, the object determination unit 104 determines whether at least one object is detected. When it is determined in step S203 that an object is detected, the object determination unit 104 writes a detection result (a position and size of the detected object) in the object data memory 108, and the process proceeds to step S204. On the other hand, when it is determined in step S203 that no object is detected, the process ends.

In step S204, the object determination unit 104 identifies the type of the object detected in step S203 and writes the identification result to the object data memory 108.

In step S205, the temperature control determinator 111 reads the identification result written in step S204 from the object data memory 108. Then, the temperature control determinator 111 determines whether the object type as the identification result matches the type of the object that is a target of the warm/cold sense presentation control determined in advance based on the read identification result. When it is determined in step S205 that the object type as the identification result matches the type of the object that is a target of the predetermined warm/cold sense presentation control, the process proceeds to step S206. On the other hand, when it is determined in step S205 that the object type as the identification result does not match the type of the object that is a target of the predetermined warm/cold sense presentation control, the process proceeds to step S207.

In step S206, the temperature decider 112 receives information about the object type from the temperature control determinator 111. The temperature decider 112 reads the temperature data of the corresponding object type from the temperature data list stored in the temperature data table memory 109 (decides the temperature of the object occupied area), and outputs the read temperature data to the temperature control determinator 111. The temperature control determinator 111 associates the warm/cold sense presentation area 304 (405) of the corresponding object with the received temperature data, and writes the associated information as the temperature control data in the temperature control memory 113.

In step S207, the temperature control determinator 111 determines whether the process from step S204 to step S206 is completed for all the objects detected by the object determination unit 104. When it is determined in step S207 that the process is completed for all the detected objects, the process proceeds to step S208. On the other hand, when it is determined in step S207 that the process is not completed for all the detected objects, the process returns to step S204, and the subsequent steps are sequentially executed.

In step S208, the temperature control unit 110 reads the temperature data associated with each section in the warm/cold sense presentation area 304 (405) from the temperature control memory 113, and controls the temperature of each section in the warm/cold sense presentation area 304 (405) of the warm/cold sense presentation device 114 to be the read temperature. Accordingly, the user of the warm/cold sense presentation apparatus 100 can receive presentation of the warm/cold sense by touching the warm/cold sense presentation device 401 with a finger, a palm, or the like.

The warm/cold sense presentation apparatus 100 as described above enables to determine whether to execute the temperature control only for an object occupied area that is an area occupied by a desired object to be a target of the temperature control in an image. When it is determined that the temperature control is to be executed as a result of the determination, the temperature of only the object occupied area can be decided. Accordingly, the user can understand the temperature of the desired object in the image by touching the object occupied area in the warm/cold sense presentation device 401.

Further, regardless of the object type, the degree of freedom can be set by, for example, limiting the upper limit or the lower limit of the temperature in the temperature control range in the object occupied area. In the warm/cold sense presentation apparatus 100, the temperature control determinator 111 can set a plurality of object occupied areas. In this case, the temperature control determinator 111 determines whether to execute the temperature control for each object occupied area. The temperature decider 112 may then decide the temperature for each object occupied area.

With such a configuration, for example, when an animal including a human is identified as the object type, the temperature control determinator 111 can set object occupied areas for the respective parts (for example, a head, a chest, and the like) of the body of the animal and determine whether to execute temperature control for the respective object occupied areas. The temperature decider 112 can then decide the temperatures of the respective object occupied areas set for the respective body parts. Accordingly, the user can understand the temperatures of the parts of the body. That is, the user can understand which part of the body is at a high temperature or a low temperature.

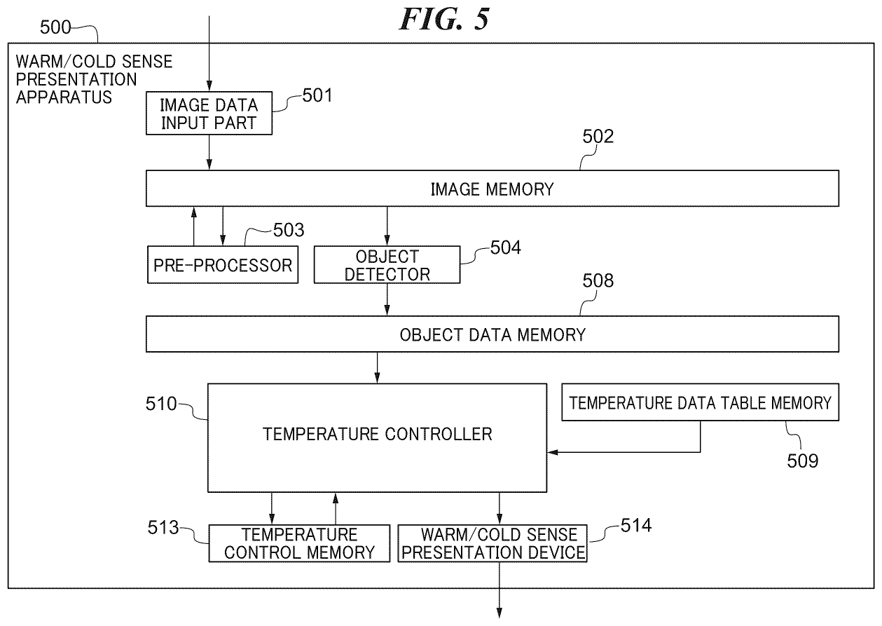

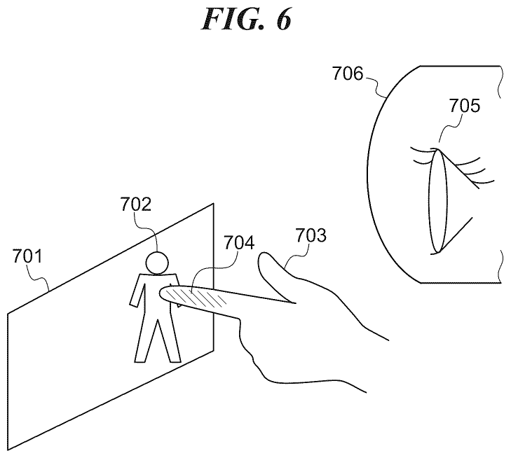

Hereinafter, a second embodiment will be described with reference to FIGS. 5 and 6. Differences from the first embodiment will be mainly described, and the description of the same matters as that of the first embodiment will be omitted. The second embodiment is different from the first embodiment mainly in the configurations of the temperature control unit and the warm/cold sense presentation part, and is the same as the first embodiment in the other matters. FIG. 5 is a block diagram illustrating a hardware configuration of a warm/cold sense presentation apparatus according to the second embodiment.

The warm/cold sense presentation apparatus 500 includes an image data input part 501, an image memory 502, a pre-processor 503, an object determination unit 504, and an object data memory 508. In addition, the warm/cold sense presentation apparatus 500 includes a temperature data table memory 509, a temperature control unit 510, a temperature control memory 513, and a warm/cold sense presentation device 514. The image data input part 501 is similar to the image data input part 101 in the first embodiment, the image memory 502 is similar to the image memory 102 in the first embodiment, and the pre-processor 503 is similar to the pre-processor 103 in the first embodiment, and thus, description thereof will be omitted. Further, the object determination unit 504 is similar to the object determination unit 104 in the first embodiment, and the object data memory 508 is similar to the object data memory 108 in the first embodiment, and thus, description thereof will be omitted. Further, the temperature data table memory 509 is similar to the temperature data table memory 109 in the first embodiment, and the temperature control memory 513 is similar to the temperature control memory 113 in the first embodiment, and thus, description thereof will be omitted.

FIG. 6 is a schematic view illustrating a use state of the warm/cold sense presentation apparatus shown in FIG. 5. As shown in FIG. 6, a user who uses the warm/cold sense presentation apparatus 500 wears a head-mounted display (a display unit) 706. The head-mounted display 706 displays a virtual reality space 701 as an image. This allows the user to visually recognize a human 702 that is an object in the virtual reality space 701.

The virtual reality space 701 is the image obtained from the image data input to the image data input part 501. The warm/cold sense presentation device 514 is achieved as a glove-shaped warm/cold sense presentation device 703 that can be worn on a hand of the user who visually recognizes the human 702 in the virtual reality space 701. The form of the warm/cold sense presentation device 703 may have, for example, a ring shape that can be worn on a fingertip, and the form is not limited to the above. That is, the form of the warm/cold sense presentation device 703 may be any form as long as the form is capable of presenting a warm/cold sense and is wearable on the body of the user (for example, the hand or finger of the user).

Further, Peltier elements as the temperature adjustment unit to adjust the temperature to be the temperature decided by the temperature control unit 510 are arranged in the glove-shaped warm/cold sense presentation device 703, and is in contact with a finger, a palm of a hand, a back of the hand, or the like of the user. The temperature control unit 510 has a function of calculating the position and size of the virtual reality space 701 and determining whether the user is in contact with the human 702.

The user can touch the human 702 in the virtual reality space 701 displayed on the head-mounted display 706 via the warm/cold sense presentation device 703 in a state where the user wears the head-mounted display 706 and the warm/cold sense presentation device 703. At this time, when the temperature control for the object type “human” is set to be available in advance, the temperature control unit 510 determines whether the finger 704 of the user is in contact with the human 702. When it is determined that the finger 704 is in contact with the human 702, the temperature control unit 510 reads the temperature data of the object type “human” from the temperature data table memory 509. The temperature control unit 510 controls the temperature of the Peltier element arranged in the warm/cold sense presentation device 703 so that the finger 704 of the user can feel the temperature of the object type “human”. Thus, the user can understand the temperature of the human 702 by touching the human 702 with the finger 704. On the other hand, when it is determined that the finger 704 is not in contact with the human 702, the temperature control unit 510 does not perform the temperature control of the Peltier element.

Note that a method of determining whether the finger 704 is in contact with the human 702 is not particularly limited. For example, invisible laser light is emitted from the head-mounted display 706, and reflected light from the finger 704 is received by a sensor of the head-mounted display 706. Accordingly, the temperature control unit 510 can measure distance from the head-mounted display 706 to the finger 704. Then, it is possible to determine whether the finger 704 is in contact with the human 702 based on the difference between the distance and angle between a pupil position 705 of the user converted into an arbitrary coordinate in the virtual reality space 701 to the finger 704 and the distance and angle between the pupil position 705 and the human 702. For example, when the difference falls within a certain numerical value, the temperature control unit 510 determines that the finger 704 is in contact with the human 702. On the other hand, when the difference does not fall within the predetermined numerical value, the temperature control unit 510 determines that the finger 704 is not in contact with the human 702.

The temperature control unit 510 may control the warm/cold sense presentation with the warm/cold sense presentation device 703 in consideration of attenuation of the temperature according to the distance between the finger 704 and the human 702. For example, a distance in a state in which the finger 704 (the warm/cold sense presentation device 703) is in contact with the human 702 shall be defined as 100%. A relatively short distance in a state where the finger 704 is not in contact with the human 702 shall be defined as 0%. Then, the temperature may be linearly changed according to the distance from 0% to 100%. For example, when the distance is 0%, the temperature control is not performed, and when the distance changes to 100%, the temperature control is performed to increase the temperature linearly.

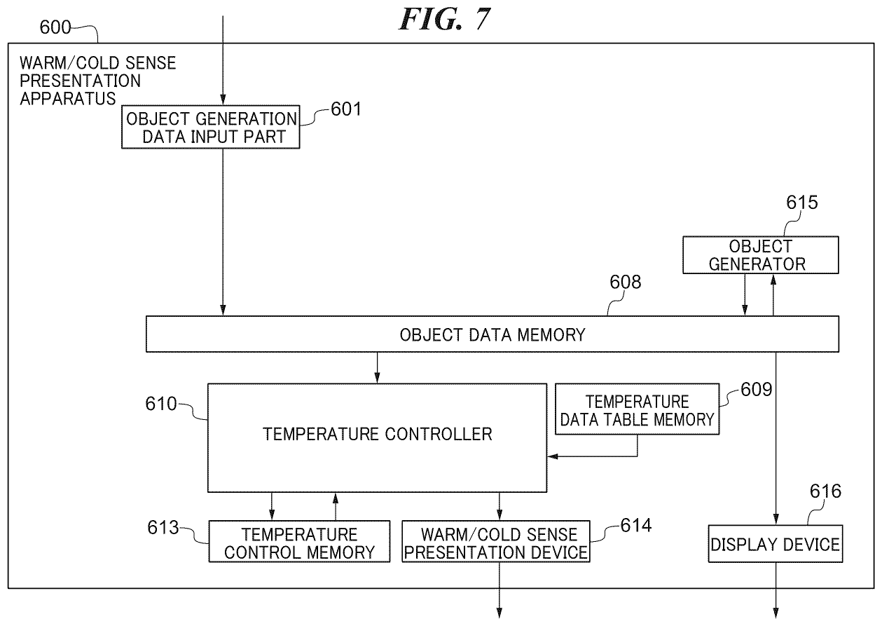

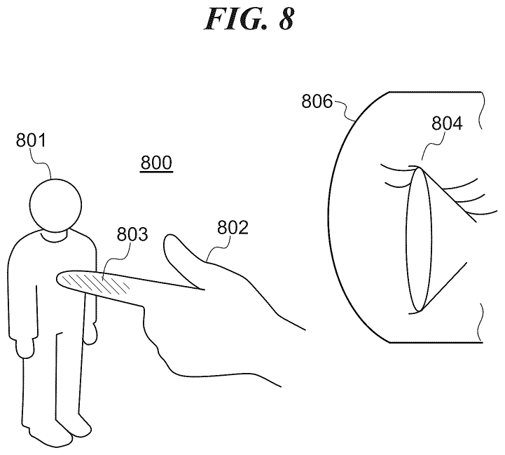

Hereinafter, a third embodiment will be described with reference to FIGS. 7 and 8. Differences from the above-described embodiments will be mainly described, and description of the same matters as that of the above-mentioned embodiments will be omitted. The third embodiment is different from the above-described embodiments mainly in that a warm/cold sense presentation apparatus 600 includes an object generator 615 and a display device 616, and is the same as the second embodiment in other matters.

FIG. 7 is a block diagram illustrating a hardware configuration of the warm/cold sense presentation apparatus 600 according to the third embodiment. The warm/cold sense presentation apparatus 600 includes an object generation data input part 601, an object data memory 608, a temperature data table memory 609, a temperature control unit 610, a temperature control memory 613, a warm/cold sense presentation device 614, the object generator 615, and the display device 616.

FIG. 8 is a schematic view illustrating a use state of the warm/cold sense presentation apparatus 600 shown in FIG. 7. As shown in FIG. 8, when the user uses the warm/cold sense presentation apparatus 600, the user wears a head-mounted display (display unit) 806 in the third embodiment in the same manner as the second embodiment. The head-mounted display 806 displays a virtual reality space 800 including a polygon object (three-dimensional image) 801 as an image. This allows the user to view the polygon object 801 in the virtual reality space 800.

In the third embodiment, the polygon object 801 is a human. Further, the warm/cold sense presentation device 614 in the third embodiment is achieved as a glove-shaped warm/cold sense presentation device 802 that can be worn on a hand of a user, similarly to the warm/cold sense presentation device 703 in the second embodiment. The form of the warm/cold sense presentation device 802 may have, for example, a ring shape that can be worn on a fingertip, and the form is not limited to the above. That is, the form of the warm/cold sense presentation device 703 may be any form as long as the form is capable of presenting a warm/cold sense and is wearable on the hand or finger of the user.

The object generation data input part (image data input unit) 601 has an I/F to which three-dimensional object generation data (image data) is input from the outside. The I/F is not particularly limited, and it may be an I/F into which a memory card capable of reading and writing data at a high speed, such as an SD card or a CFexpress card, can be inserted and removed. The object generation data input part 601 reads the three-dimensional object generation data recorded in the memory card and writes the three-dimensional object generation data in the object data memory 608.

The “three-dimensional object generation data” is, for example, data including local three-dimensional coordinates of polygon vertices for generating a plurality of polygons constituting an object (for example, the polygon object 801). The data also includes texture mapping coordinates for pasting a texture on each polygon surface, texture data, material data of each polygon surface, and object type information for deciding temperature of the object.

The object generator 615 generates the polygon object 801 displayed in the virtual reality space 800 based on the three-dimensional object generation data. The display device 616 performs a rendering process on the polygon object 801 generated by the object generator 615 and displays the processing result (rendering result) as image data. Accordingly, the polygon object 801 is displayed in the virtual reality space 800 on the head-mounted display 806, and the user can visually recognize the polygon object 801.

In the present embodiment, the temperature control unit 610 has the function as the object detection unit to detect the polygon object 801 and the function as the type identification unit to identify the type of the polygon object 801. In the warm/cold sense presentation apparatus 600, the object generator 615 may have the function as the object detection unit and the function as the type identification unit. The temperature control unit 610 has a function of calculating the position and size of the virtual reality space 800 and determining whether the user is in contact with the polygon object 801.

The user can touch the polygon object 801 in the virtual reality space 800 displayed on the head-mounted display 806 via the warm/cold sense presentation device 802 in a state where the user wears the head-mounted display 806 and the warm/cold sense presentation device 802. At this time, when the temperature control for the object type “human” is set to be valid in advance, the temperature control unit 610 determines whether a finger 803 of the user is in contact with the polygon object 801. When it is determined that the finger 803 is in contact with the polygon object 801, the temperature control unit 610 reads the temperature data of the object type “human” from the temperature data table memory 609. The temperature control unit 610 controls the temperature of the Peltier element arranged in the warm/cold sense presentation device 802 so that the finger 803 of the user can feel the temperature of the object type “human”. Thus, the user can understand the temperature of the human by touching the polygon object 801 with the finger 803. On the other hand, when it is determined that the finger 803 is not in contact with the polygon object 801, the temperature control unit 610 does not perform the temperature control of the Peltier element.

Note that the method of determining whether the finger 803 is in contact with the polygon object 801 is not particularly limited. For example, invisible laser light is emitted from the head-mounted display 806, and reflected light from the finger 803 is received by a sensor of the head-mounted display 806. Accordingly, the temperature control unit 610 can measure the distance from the head-mounted display 806 to the finger 803. The temperature control unit 610 obtains a positional relationship between a finger position coordinate generated based on the distance and angle between a pupil position 804 of the user converted into an arbitrary coordinate in the virtual reality space 800 and the finger 803 and the inner coordinate of the polygon object 801 in the virtual reality space 800. Based on this positional relationship, it is possible to determine whether the finger 803 is in contact with the polygon object 801. For example, when the finger position coordinate is positioned at the inner coordinate, it is determined that the finger 803 is in contact with the polygon object 801. On the other hand, when the finger position coordinate is not positioned at the inner coordinate, it is determined that the finger 803 is not in contact with the polygon object 801.

In addition, various notifications may be performed. For example, when the temperature of the temperature data associated with the polygon object 801 is lower than 20 degrees, the display device 616 may notify the user that the polygon object 801 is cold when displaying the polygon object 801 after the rendering process. The notification method is not particularly limited, and examples thereof include a method of drawing an effect and a method of displaying a frame for the notification around the polygon object 801. Other notification methods include a method of drawing an icon for the notification near the polygon object 801, a method of displaying a message for the notification, a method of emitting a sound for the notification, and the like. Such a notification allows the user to understand that the polygon object 801 is cold before touching the polygon object 801.

In addition, when the temperature of the temperature data associated with the polygon object 801 is higher than 40 degrees, the display device 616 may notify the user that the polygon object 801 is hot when displaying the polygon object 801 after the rendering process. The notification method is not particularly limited, and examples thereof include a method of drawing an effect and a method of displaying a frame for notification around the polygon object 801. Other notification methods include a method of drawing an icon for the notification near the polygon object 801, a method of displaying a message for the notification, a method of emitting a sound for the notification, and the like. Such a notification allows the user to understand that the polygon object 801 is hot before touching the polygon object 801.

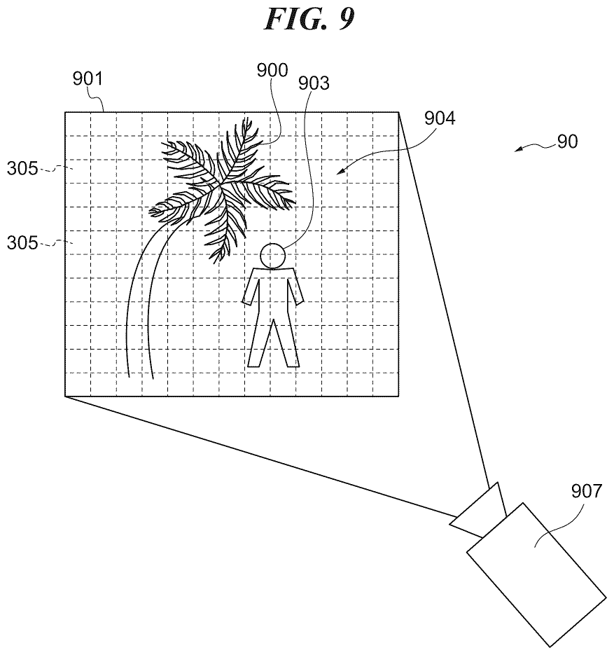

Hereinafter, a fourth embodiment will be described with reference to FIG. 9. Differences from the above-described embodiments will be mainly described, and description of the same matters as that of the above-mentioned embodiments will be omitted. The fourth embodiment is different from the above-described embodiments mainly in the configuration of the warm/cold sense presentation device, and the other configurations are the same as those of the first embodiment.

FIG. 9 is a schematic view illustrating a configuration of a warm/cold sense presentation apparatus according to the fourth embodiment. The warm/cold sense presentation apparatus 90 includes a screen (a display unit) 901 and a projector (an image irradiation device) 907 disposed apart from the screen 901. The screen 901 may be omitted from the configuration of the warm/cold sense presentation apparatus 90. In this case, the screen 901 or a screen equivalent thereto is prepared separately from the warm/cold sense presentation apparatus 90. The projector 907 irradiates (projects) an image 904 obtained from input image data onto the screen 901. As a result, the image 904 is displayed on the screen 901. Then, the position of the screen 901 is adjusted with respect to the irradiation angle of view of the projector 907.

The image 904 includes a human 903 and a tree 900. The screen 901 is a warm/cold sense presentation unit having a plurality of Peltier elements (warm/cold sense presentation elements 305) arranged in a matrix on the back side thereof. A portion of the screen 901 that overlaps the human 903 (the portion of the screen 901 on which the human 903 is projected) is a temperature control target and the temperature in the portion is adjusted. The user can feel the temperature corresponding to the human 903 by touching the portion of the screen 901 corresponding to the human 903 while viewing the human 903 projected on the screen 901.

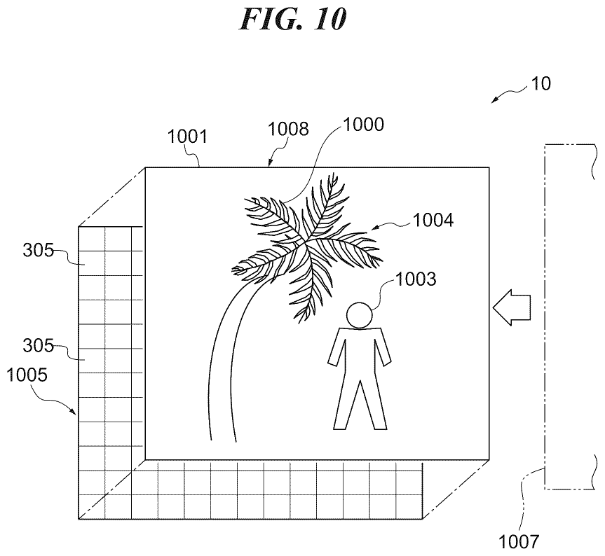

Hereinafter, a fifth embodiment will be described with reference to FIG. 10. Differences from the above-described embodiments will be mainly described, and description of the same matters as that of the above-mentioned embodiments will be omitted. The fifth embodiment is different from the above-described embodiments mainly in the configuration of the warm/cold sense presentation unit, and the other configurations are the same as those of the first embodiment.

FIG. 10 is a schematic view illustrating a configuration of a warm/cold sense presentation apparatus 10 according to the fifth embodiment. The warm/cold sense presentation apparatus 10 includes a warm/cold sense presentation device 1005 and a printing device 1007. The printing device 1007 may be omitted from the configuration of the warm/cold sense presentation apparatus 10. In this case, the printing device 1007 or a printing device equivalent thereto is prepared separately from the warm/cold sense presentation apparatus 10. It is preferable that the printing device 1007 is communicably connected to the warm/cold sense presentation apparatus 10. The printing device 1007 forms and prints an image 1004 obtained from input image data on a sheet 1001, and outputs (prints out) an obtained printed matter 1008. As a result, an image 1004 is displayed on the sheet 1001. The image 1004 includes a human 1003 and a tree 1000.

The warm/cold sense presentation device 1005 has a plurality of Peltier elements (warm/cold sense presentation elements 305) arranged in a matrix on the front side thereof. Note that each Peltier element of the warm/cold sense presentation device 1005 may have a convex shape. The warm/cold sense presentation apparatus 10 is used by overlapping a printed matter 1008 on the warm/cold sense presentation device 1005. The warm/cold sense presentation device 1005 preferably includes a detector detecting that the printed matter 1008 is overlapped and a position adjuster for positioning with the printed matter 1008. The portion of the warm/cold sense presentation device 1005 overlapping the human 1003 is the temperature control target and the temperature in the portion is adjusted. The user can feel the temperature corresponding to the human 1003 by touching the portion on the printed matter 1008 corresponding to the human 1003 while viewing the human 1003 formed on the printed matter 1008.

In each of the above-described embodiments, the warm/cold sense presentation apparatus is applied to the image processing apparatus as an example, this is not limited. For example, the warm/cold sense presentation apparatus may contain the image processing apparatus. Another application example may be a system including an image processing apparatus and a warm/cold sense presentation apparatus that is configured separately from the image processing apparatus, receives temperature information generated by the image processing apparatus, and presents warm/cold sense.

According to the present disclosure, it is possible to decide whether to perform temperature control on a desired object in an image and have a degree of freedom in a control range of a presented temperature.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An image processing apparatus comprising:
one or more processors; and
a memory storing instructions which, when executed by the one or more processors, cause the one or more processors to function as:
an image data input unit configured to input image data of the image;
an object detection unit configured to detect the object in the image based on the image data;
a type identification unit configured to identify a type of the object detected by the object detection unit;
a determination unit configured to determine whether to perform temperature control to an object occupied area that is occupied by the object in the image based on an identification result of the type identification unit; and
a temperature decision unit configured to decide a temperature of the object occupied area in a case where it is determined to perform the temperature control as a determination result of the determination unit.

2. The image processing apparatus according to claim 1, further comprising a setting unit configured to set the type of the object in advance,
wherein the determination unit determines to perform the temperature control in a case where the type of the object identified by the type identification unit matches the type of the object set by the setting unit in advance, and determines not to perform the temperature control in a case where the type of the object identified by the type identification unit does not match the type of the object set by the setting unit in advance.

3. The image processing apparatus according to claim 1, wherein the determination unit is able to set a plurality of object occupied areas and determine whether to perform the temperature control for each of the plurality of object occupied areas, and
wherein the temperature decision unit is able to decide a temperature for each of the plurality of object occupied areas.

4. The image processing apparatus according to claim 1, further comprising a storage unit configured to store temperature information about a temperature for each type of the object in advance,
wherein the temperature decision unit decides the temperature of the object occupied area based on the temperature information.

5. The image processing apparatus according to claim 1, wherein the temperature decision unit is able to change a decision method of the temperature in accordance with the type of the object when deciding the temperature of the object occupied area.

6. The image processing apparatus according to claim 1, wherein the temperature decision unit is able to set at least one of an upper limit of the temperature and a lower limit of the temperature in accordance with the type of the object when deciding the temperature of the object occupied area.

7. The image processing apparatus according to claim 1, further comprising a scene determination unit configured to determine a scene of the image, and
wherein the temperature decision unit decides the temperature of the object occupied area based on a determination result of the scene determination unit.

8. The image processing apparatus according to claim 1, wherein the determination unit sets, when the type identification unit identifies an animal including a human as the type of the object, the object occupied area for each part of a body of the animal and determines whether to perform the temperature control for each part of the body, and
wherein the temperature decision unit decides the temperature of the object occupied area set for each part of the body.

9. The image processing apparatus according to claim 8, further comprising a display unit configured to display the image, and
wherein the display unit is able to display a degree of deviation between the temperature of each object occupied area decided by the temperature decision unit and an average body temperature of the animal on the image.

10. The image processing apparatus according to claim 1, further comprising a display unit configured to display the image, and
wherein the display unit is able to display information corresponding to the temperature of the object occupied area decided by the temperature decision unit.

11. The image processing apparatus according to claim 1, further comprising:
a display unit configured to display the image; and
a temperature adjustment unit configured to adjust a temperature of the image displayed on the display unit to be the temperature of the object occupied area decided by the temperature decision unit.

12. The image processing apparatus according to claim 11, wherein the temperature adjustment unit is wearable on a body of a user who uses the display unit.

13. The image processing apparatus according to claim 11, wherein the display unit displays a virtual reality space as the image.

14. The image processing apparatus according to claim 11, wherein the display unit displays a three-dimensional image as the image.

15. The image processing apparatus according to claim 11, wherein the display unit displays the image on a screen by projecting the image onto the screen.

16. The image processing apparatus according to claim 11, wherein the display unit displays the image by printing the image on a sheet.

17. The image processing apparatus according to claim 1, further comprising an authentication unit configured to authenticate the type of the object identified by the type identification unit, and
wherein the determination by the determination unit and the decision by the temperature decision unit are performed in a case where the type of the object identified by the type identification unit is authenticated by the authentication unit.

18. The image processing apparatus according to claim 1, wherein the object detection unit detects the object using machine learning.

19. The image processing apparatus according to claim 1, wherein the type identification unit identifies the type of the object using machine learning.

20. The image processing apparatus according to claim 1, wherein the object detection unit and the type identification unit are integrally constituted as a single unit or are separately constituted as independent units.

21. A warm/cold sense presentation apparatus comprising:
one or more processors; and
a memory storing instructions which, when executed by the one or more processors, cause the one or more processors to function as:
an image data input unit configured to input image data of the image;
an object detection unit configured to detect the object in the image based on the image data;
a type identification unit configured to identify a type of the object detected by the object detection unit;
a determination unit configured to determine whether to perform temperature control to an object occupied area that is occupied by the object in the image based on an identification result of the type identification unit; and
a temperature decision unit configured to decide a temperature of the object occupied area in a case where it is determined to perform the temperature control as a determination result of the determination unit.

22. A control method for an image processing apparatus, the control method comprising:
an image data input step of inputting image data of the image;
an object detection step of detecting the object in the image based on the image data;
a type identification step of identifying a type of the object detected in the object detection step;
a determination step of determining whether to perform temperature control to an object occupied area that is occupied by the object in the image based on an identification result of the type identification step; and
a temperature decision step of deciding a temperature of the object occupied area in a case where it is determined to perform the temperature control as a determination result of the determination step.

23. A non-transitory computer-readable storage medium storing a control program causing a computer to execute a control method for an image processing apparatus, the control method comprising:
an image data input step of inputting image data of the image;
an object detection step of detecting the object in the image based on the image data;
a type identification step of identifying a type of the object detected in the object detection step;
a determination step of determining whether to perform temperature control to an object occupied area that is occupied by the object in the image based on an identification result of the type identification step; and
a temperature decision step of deciding a temperature of the object occupied area in a case where it is determined to perform the temperature control as a determination result of the determination step.
